(19) United States
(12) Patent Application Publication
(10) Pub. No.: US 2016/0353021 A1
(43) Pub. Date: Dec. 1, 2016

(54) CONTROL APPARATUS, DISPLAY CONTROL METHOD AND NON-TRANSITORY COMPUTER READABLE MEDIUM

(71) Applicant: CANON KABUSHIKI KAISHA, Tokyo (JP)

(72) Inventor: Naotaka MURAKAMI, Tokyo (JP)

(21) Appl. No.: 15/165,691

(22) Filed: May 26, 2016

(30) Foreign Application Priority Data
May 28, 2015 (JP) 2015-108636

(51) Int. Cl. H04N 5/232; G06F 3/0485; G06F 3/0484

(52) U.S. Cl. CPC H04N 5/23238; G06F 3/04842; G06F 3/0485; H04N 5/23293

(57) ABSTRACT

A control apparatus according to the present invention: selects a part of an original image; performs displaying the selected part of the original image in a display unit; records, in association with the original image, information which indicates the part of the original image has already been displayed in the display unit in a storage unit; and performs displaying the original image in the display unit based on the information recorded in the storage unit so as to discriminate which part of the original image has already been displayed.

### BACKGROUND OF THE INVENTION

Field of the Invention

The present invention relates to a control apparatus, a display control method and a non-transitory computer readable medium.

Description of the Related Art

In recent years, digital cameras capable of generating an omnidirectional image in which a view around a photographer in all directions is imaged, a panoramic image in which a wide-range view is imaged, and the like have been available. The image size of an image in which the wide-range view is imaged (wide-range image) such as the omnidirectional image or the panoramic image, is large. Accordingly, in the reproduction of a wide-range image in general, the area of apart of the wide-range image (partial area) is displayed. The omnidirectional image has a shape of an entire celestial sphere, and hence, in the reproduction of the omnidirectional image, a geometric transformation process is per formed on the omnidirectional image and the partial area of the omnidirectional image having been subjected to the geometric transformation process is displayed (Japanese Patent Application Laid-open No. 2013-27021).

However, the method described above has a problem in that a user cannot easily determine which area in the wide-range image the displayed partial area corresponds to. As a method for solving this problem, Japanese Patent Application Laid-open No. 2013-27021 discloses a method that displays, together with the partial area, an image indicative of which area in the wide-range image the partial area corresponds to.

### SUMMARY OF THE INVENTION

However, in a case where the technique disclosed in Japanese Patent Application Laid-open No. 2013-27021is used, there are cases where the user cannot determine whether or not the displayed partial area is an area that has already been displayed. For example, as one of user's demands regarding the wide-range image in which a large number of persons are shown, there is a demand that the user desires to check expressions of all of the persons while changing the target partial area to be displayed. With regard to such a demand, it is preferable that all, without exception, of the persons shown in the wide-range image are displayed by partial display and, at the same time, the same person is not displayed repeatedly by the partial display. With this, the user can efficiently check the expressions of all of the persons. However, as described above, with the conventional method, the user cannot easily determine whether or not the displayed partial area is an area that has already been displayed. Accordingly, there are cases where the same partial area (the same person) is displayed repeatedly, or part of the persons are not displayed by the partial display. As a result, there are cases where the user cannot efficiently check the expressions of all of the persons.

The present invention provides a technique that allows a user to easily grasp an already-displayed area and the other area in an area of an original image.

The present invention in its first aspect provides a control apparatus comprising:

a processor; and

a memory storing a program which, when executed by the processor, causes the control apparatus to:

select a part of an original image;

perform displaying the selected part of the original image in a display unit;

record, in association with the original image, information which indicates the part of the original image has already been displayed in the display unit, in a storage unit; and

perform displaying the original image in the display unit based on the information recorded in the storage unit so as to discriminate which part of the original image has already been displayed.

The present invention in its second aspect provides a display control method comprising:

selecting a part of an original image;

performing displaying the selected part of the original image in a display unit;

recording, in association with the original image, information which indicates the part of the original image has already been displayed in the display unit in a storage unit; and

performing displaying the original image in the display unit based on the information recorded in the storage unit so as to discriminate which part of the original image has already been displayed.

The present invention in its third aspect provides a non-transitory computer readable medium that stores a program, wherein the program causes a computer to execute:

selecting a part of an original image;

performing displaying the selected part of the original image in a display unit;

recording, in association with the original image, information which indicates the part of the original image has already been displayed in the display unit in a storage unit; and

performing displaying the original image in the display unit based on the information recorded in the storage unit so as to discriminate which part of the original image has already been displayed.

According to the present invention, the user can easily grasp the already-displayed area and the other area in the area of the original image.

Further features of the present invention will become apparent from the following description of exemplary embodiments with reference to the attached drawings.

### BRIEF DESCRIPTION OF THE DRAWINGS

FIG. 1 is a block diagram showing an example of a functional configuration of a digital camera according to the present embodiment;

FIG. 2 is a view showing an example of an omnidirectional image according to the present embodiment;

FIG. 3 is a view showing an example of the omnidirectional image and a partial area according to the present embodiment;

FIG. 4 is a view showing an example of a state in which a partial image according to the present embodiment is displayed;

FIG. 5 is a view showing an example of the omnidirectional image and the partial area according to the present embodiment;

FIG. 6 is a view showing an example of the state in which the partial image according to the present embodiment is displayed;

FIG. 7 is a flowchart showing an example of an operation of the digital camera according to a first embodiment;

FIG. 8 is a view showing an example of a first assist image according to the first embodiment;

FIGS. 9A and 9B are views each showing an example of the first assist image according to the first embodiment;

FIG. 10 is a flowchart showing an example of the operation of the digital camera according to a second embodiment;

FIG. 11 is a view showing an example of the first assist image according to the second embodiment; and

FIG. 12 is a view showing an example of a second assist image according to a third embodiment.

### DESCRIPTION OF THE EMBODIMENTS

### First Embodiment

Hereinbelow, a control apparatus and a control method according to a first embodiment of the present invention will be described. Note that, in the following description, an example in which the control apparatus according to the present embodiment is provided in a digital camera will be described, but the control apparatus is not limited thereto. The control apparatus according to the present embodiment may also be provided in a personal computer, a smartphone, or the like.

### Configuration

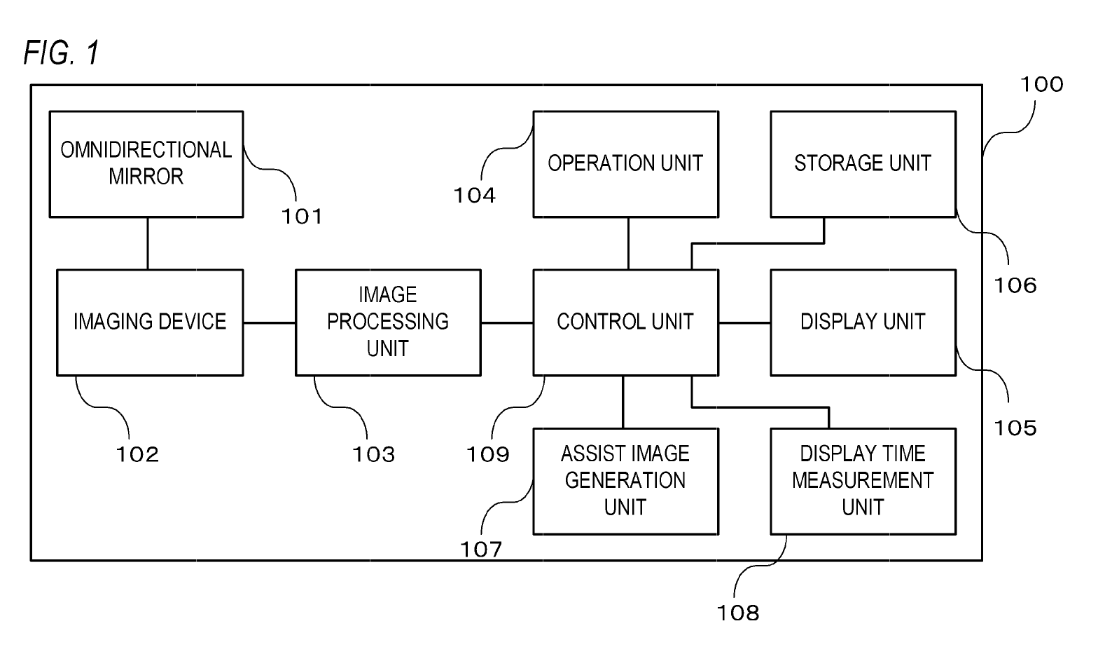

First, an example of a configuration of a digital camera according to the present embodiment will be described. FIG. 1 is a block diagram showing an example of a functional configuration of a digital camera 100 according to the present embodiment.

An omnidirectional mirror 101 reflects light from all directions (360 degrees) around the digital camera 100 by specular reflection to thereby guide the light to an imaging device 102. As the omnidirectional mirror 101, it is possible to use a hyperboloid mirror, a spherical mirror, a circular fisheye lens, or the like.

The imaging device 102 performs imaging that uses light from the omnidirectional mirror. Specifically, the imaging device 102 converts light from the omnidirectional mirror to an electrical signal (image data). Subsequently, the imaging device 102 outputs the obtained image data to an image processing unit 103. As the imaging device 102, it is possible to use a CCD sensor, a CMOS sensor, or the like.

The image processing unit 103 performs an image process and a compression process on the image data outputted from the imaging device 102. Subsequently, the image processing unit 103 outputs the image data having been subjected to the processes. The image data outputted from each of the imaging device 102 and the image processing unit 103 represents an omnidirectional image in which a view in all directions around the digital camera 100 is imaged. In the present embodiment, as the image process, a distortion correction process that corrects the distortion of the image is performed. In the present embodiment, an image represented by the image data having been subjected to the distortion correction process is described as “an original image” or “a plane image”.

Note that the image process is not limited to the distortion correction process. As the image process, a shake correct ion process that corrects image fluctuations caused by the shake of the digital camera 100, a brightness correction process that corrects the brightness of the image, a color correction process that corrects the color of the image, and a range correction process that corrects the dynamic range of the image may also be performed.

An operation unit 104 is a reception unit that receives a user operation to the digital camera 100. Examples of the user operation include a photographing operation that requests execution of photographing (recording of the image data obtained by imaging), a specification operation that specifies an area of a part of the original image (partial area) or changes the specified partial area, and the like. Note that the size of the partial area may be a fixed size that is predetermined by a maker or the like, or may also be a size that can be changed by a user. The same applies to the shape of the partial area.

Note that a button or a touch panel provided in the digital camera 100 can be viewed as “the operation unit 104”, and a reception unit that receives an electrical signal corresponding to the user operation to the digital camera 100 can also be viewed as “the operation unit 104”.

A display unit 105 displays an image corresponding to the image data inputted to the display unit 105. For example, the display unit 105 displays a live view image, a photographed image, a thumbnail image, a menu image, a warning image, and an assist image. The live view image is an image showing the current subject, the photographed image is an image stored in correspondence to the photographing operation, and the thumbnail image is a small image indicative of the photographed image. The menu image is an image for setting or confirming various parameters of the digital camera 100 by the user, and the warning image is an image showing various warnings. The assist image is an auxiliary image for showing a display condition of an omnidirectional image in a case where the omnidirectional image is displayed to assist a display operation by the user. As the display unit 105, it is possible to use a liquid crystal display panel, an organic EL display panel, a plasma display panel, or the like.

A storage unit 106 stores various images and information. For example, the storage unit 106 stores the image data outputted from the image processing unit 103 as the image data representing the photographed image in response to the photographing operation. In the present embodiment, the omnidirectional image having been subjected to the distortion correction process (i.e., the original image) is stored as the photographed image. In addition, the storage unit 106 stores display information as information on an already-displayed area. The already-displayed area is an area (an angle of view) that has already been displayed in the display unit 105 in the area of the photographed image. In the case where the storage unit 106 stores a plurality of photographed images, the storage unit 106 stores the display information of each of the photographed images. As the storage unit 106, it is possible to use a nonvolatile memory, an optical disk, a magnetic disk, or the like.

Note that the image before being subjected to the distortion correction process may be stored as the photographed image, and the original image may be generated using the distortion correction process in a case where the photographed image is displayed. In the case where a plurality of processes are performed in the image processing unit 103, at least part of the processes may be performed not at a timing at which the photographed image is stored but at a timing at which the photographed image is displayed.

An assist image generation unit 107 generates the assist image (image data representing the assist image) of the photographed image stored in the storage unit 106, and records the generated assist image in the storage unit 106 in association with the photographed image. In the case where the storage unit 106 stores a plurality of photographed images, the generation and the recording of the assist image are performed on each of the photographed images. In the present embodiment, the assist image generation unit 107 generates the assist image (first assist image; first auxiliary image) that shows the already-displayed area based on a selection result of a selection process described later and the display information recorded in the storage unit 106 (first generation process).

A display time measurement unit 108 measures a time during which a partial image as the photographed image in the partial area is displayed in the display unit 105.

A control unit 109 controls individual functional units of the digital camera 100. In addition, the control unit 109 performs the selection process, display control, a recording process, and the like. The selection process is a process that selects the partial area. The display control is control in which the display unit 105 is caused to perform the image display. For example, the display control is a process that outputs the target image data to be displayed to the display unit 105. The recording process is a process that records the display information in the storage unit 106. In the present embodiment, the control unit 109 is capable of executing first display control and second display control as the display control. The first display control is control in which the display unit 105 is caused to perform the display of the partial image corresponding to the selection process (the photographed image in the partial area selected by the selection process). The second display control is control in which the display unit 105 is caused to perform the display of the first assist image.

Note that the control apparatus according to the present embodiment may appropriately have at least the assist image generation unit 107, the display time measurement unit 108, and the control unit 109. In addition, one function of the control apparatus may be implemented by one processing circuit, and may also be implemented by a plurality of processing circuits. A plurality of functions of the control apparatus may be implemented by one processing circuit. For example, three functions of the selection process, the display control, and the recording process may be implemented by one processing circuit, and may also be implemented by three processing circuits respectively. A plurality of functions may be implemented by execution of a program by a central processing unit (CPU).

### First Display Control

Next, an example of the first display control according to the present embodiment will be described.

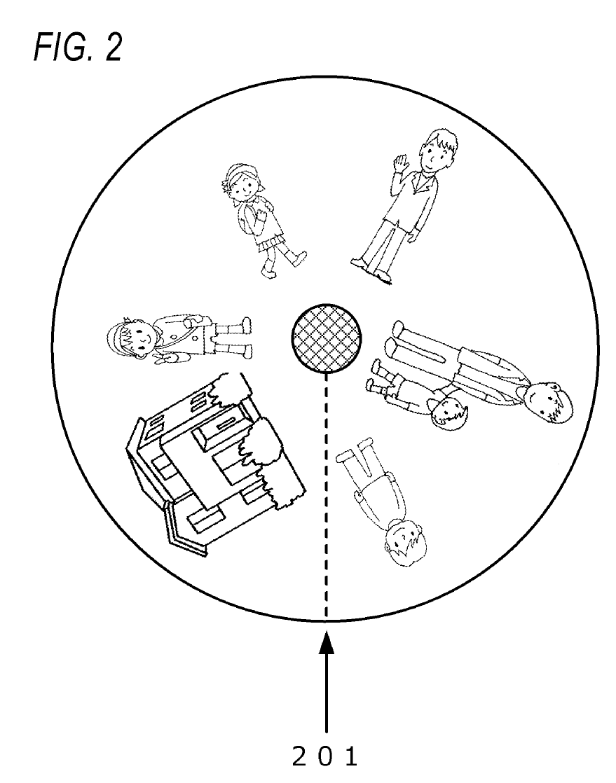

FIG. 2 is a schematic view showing an example of the omnidirectional image (the omnidirectional image before being subjected to the distortion correction process) generated in the imaging device 102. In the imaging device 102, for example, a doughnut-shaped image with the position of the digital camera 100 at the center is generated as the omnidirectional image. Such an omnidirectional image is generated because the angle of view with respect to a real image in a vertical direction is determined with the curvature of the surface of the omnidirectional mirror 101, and the real image is projected to the imaging device 102 with the distortion.

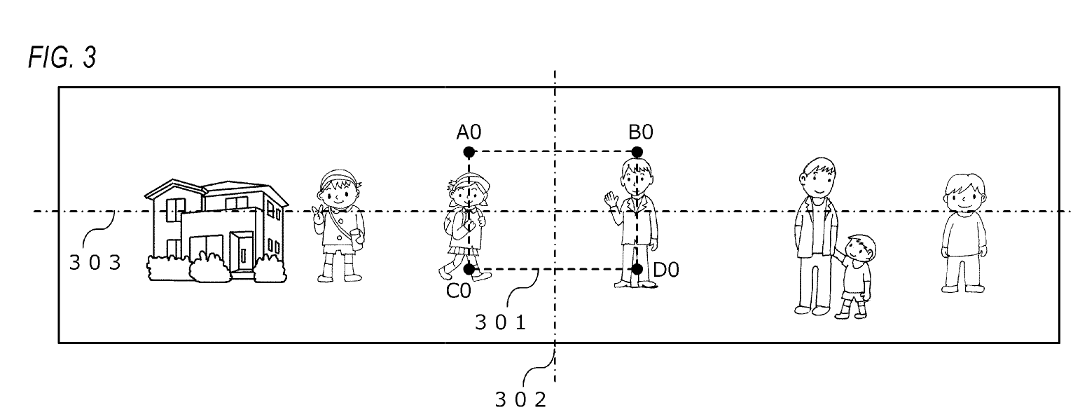

In the image processing unit 103, the distortion correction process is performed on the omnidirectional image having the distortion. With this, the distorted omnidirectional image shown in FIG. 2 is developed into a rectangular omnidirectional image (plane image) shown in FIG. 3. The omnidirectional image shown in FIG. 2 is the doughnut-shaped image, and hence it is necessary to cut the distorted image in any direction in order to develop the distorted image into the rectangular image. The omnidirectional image shown in FIG. 3 is obtained by cutting the omnidirectional image shown in FIG. 2 at a position 201 to remove the distortion.

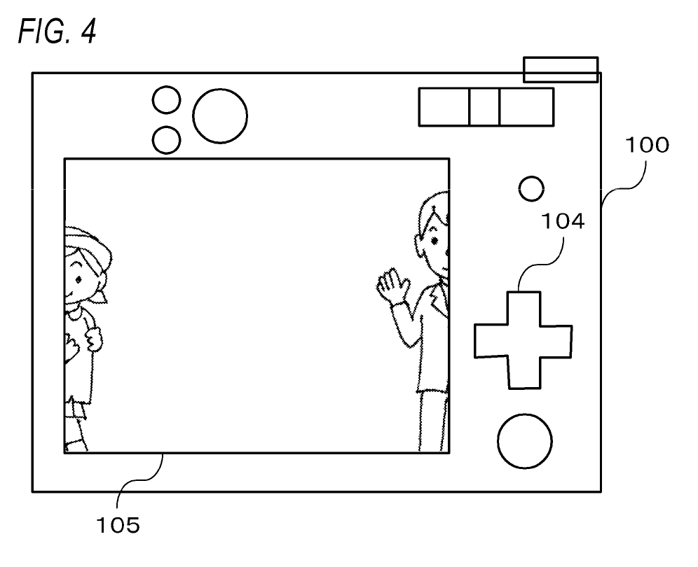

Since the image size of the plane image is large, in general, in a case where the plane image is displayed, an area of a part of the plane image (partial area) is cut out and displayed. A one-dot chain line 302 in FIG. 3 indicates the central position of the plane image in a horizontal direction, and a one-dot chain line 303 indicates the central position of the plane image in the vertical direction. An area surrounded by a broken line 301 is a partial area corresponding to the center of the plane image. The center of the partial area 301 (the area surrounded by the broken line 301) matches the center of the plane image. The partial area 301 is a rectangular area, and “a coordinate at the top left corner of the partial area 301, a coordinate at the top right corner of the partial area 301, a coordinate at the bottom left corner of the partial area 301, and a coordinate at the bottom right corner of the partial area 301” are “A0, B0, C0, and D0”. In the present embodiment, the partial area 301 as a predetermined area (initial partial area) is selected and used first. That is, in a case where the stored plane image (photographed image) is displayed for the first time, the plane image in the partial area 301 is displayed. FIG. 4 is a view showing the state. Note that an area different from the partial area 301 may be used as the initial partial area. The user may also be caused to perform the specification operation before the display of the partial image, and the area specified by the specification operation may be selected and used as the initial partial area.

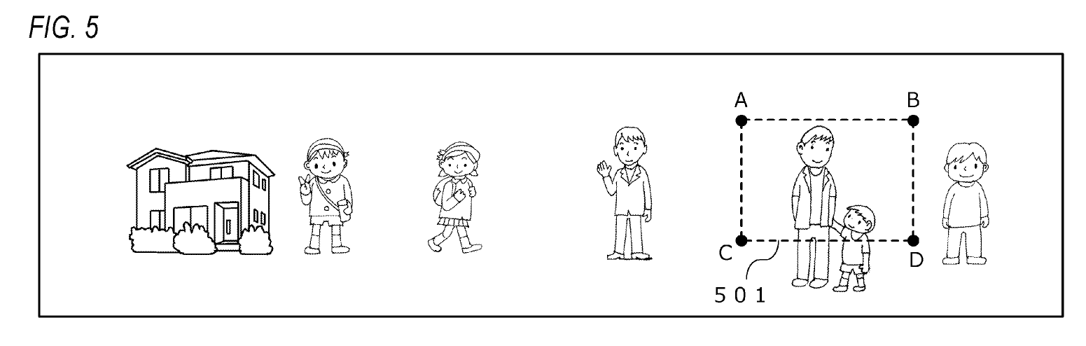

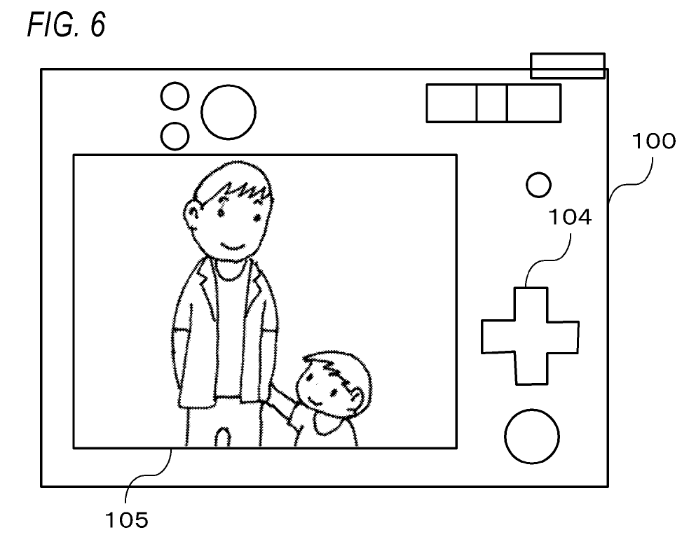

In the present embodiment, in a case where the specification operation is performed, the partial area corresponding to the specification operation is selected by the selection process, and the plane image in the selected partial area is displayed. Accordingly, the user can change the target partial area to be displayed (the partial area selected by the selection process) from the partial area 301 by performing the specification operation. For example, in a case where the specification operation that moves the partial area is performed, the partial area moves in response to the specification operation, and the display of the display unit 105 changes with the movement of the partial area. Specifically, the partial image (the plane image in the partial area) is displayed in the display unit 105, and hence the display of the display unit 105 changes such that the image moves in a direction opposite to the movement direction of the partial area. FIG. 5 is a view showing an example of the partial area after the change by the specification operation. An area surrounded by a broken line 501 is a partial area after the change by the specification operation. The partial area 501 is a rectangular area, and “a coordinate at the top left corner of the partial area 501, a coordinate at the top right corner of the partial area 501, a coordinate at the bottom left corner of the partial area 501, and a coordinate at the bottom right corner of the partial area 501” are “A, B, C, and D”. In the case where the partial area 501 is specified, the plane image in the partial area 501 is displayed. FIG. 6 is a view showing the state.

### Second Display Control

Next, an example of the second display control according to the present embodiment will be described.

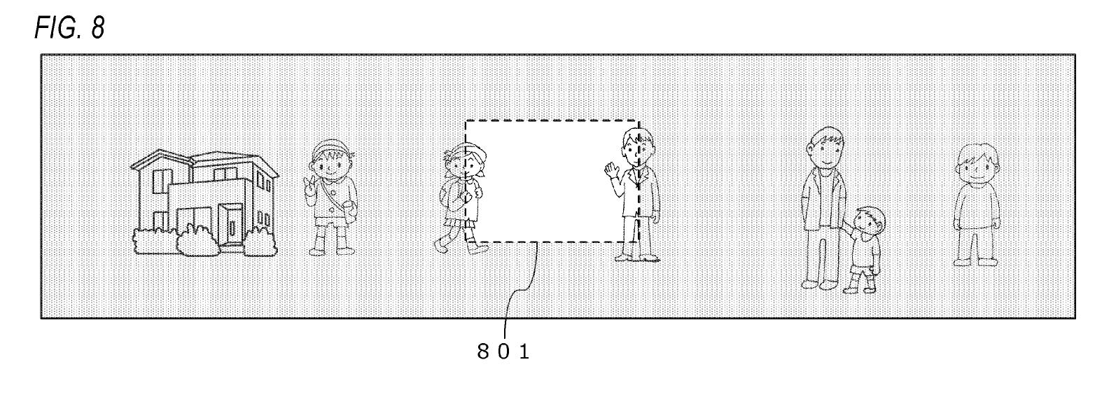

FIG. 8 is a view showing an example of the first assist image in the case where only the partial area 301 (the initial partial area) in FIG. 3 is the already-displayed area. In FIG. 8, a hatched area is a non-displayed area (an area other than the already-displayed area; an area that is not yet displayed in the display unit 105), and an area that is not hatched is an already-displayed area. An area surrounded by a broken line 801 is a partial area that is selected by the selection process (a target partial area to be displayed currently). The partial area 801 corresponds to the partial area 301 in FIG. 3.

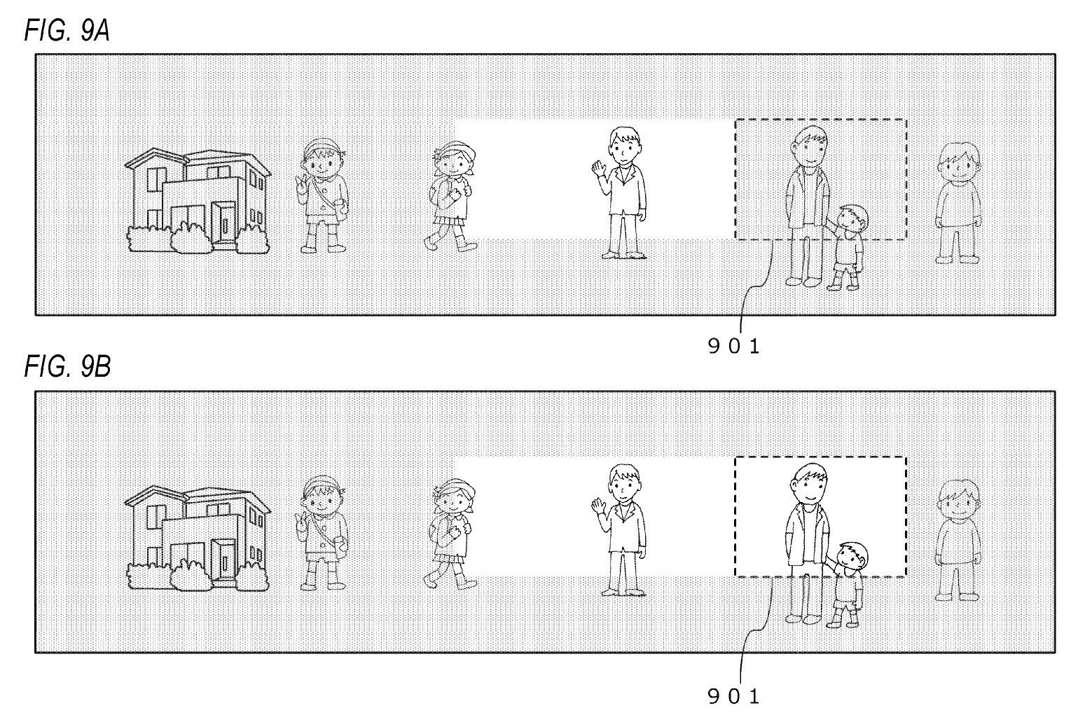

Each of FIGS. 9A and 9B is a view showing an example of the first assist image after the target partial area to be displayed is horizontally moved from the partial area 301 in FIG. 3 to the partial area 501 in FIG. 5 by the specification process. In FIGS. 9A and 9B, the non-displayed area is hatched and the already-displayed area is not hatched. An area surrounded by a broken line 901 is a target partial area to be displayed currently. The partial area 901 corresponds to the partial area 501 in FIG. 5.

Thus, in the present embodiment, an image in which the entire area of the original image is shown and the mode of image expression of the already-displayed area is different from that of the non-displayed area is used as the first assist image. With this, the user can easily distinguish between the non-displayed area and the already-displayed area and grasp them by determining the mode of the image expression. Specifically, as shown in FIGS. 8, 9A, and 9B, as the first assist image, a reduced image of the plane image is used. In the first assist image, the non-displayed area is hatched, and the already-displayed area is not hatched. With this, the user can easily distinguish between the non-displayed area and the already-displayed area and grasp them by determining whether or not the area is hatched.

In addition, in the first assist image of the present embodiment, the partial area selected by the selection process (the target partial area to be displayed currently) is displayed. Specifically, as shown in FIGS. 8, 9A, and 9B, the target partial area to be displayed currently is indicated by the broken line. With this, the user can also easily grasp the target partial area to be displayed currently.

The user can change the target partial area to be displayed such that the entire plane image is scanned thoroughly and efficiently by checking the first assist image and performing the specification operation. For example, it is possible to prevent the same area from being displayed repeatedly. As a result, the user can check the entire plane image thoroughly and efficiently with the first display control.

Note that the display method of the first assist image is not particularly limited. For example, only the first assist image may be displayed in the display unit 105. The first assist image may also be superimposed on another image (e.g., the partial image) and displayed. The first assist image may or may not be automatically displayed only during the execution of the first display control. The first assist image may be automatically displayed only during the specification operation. The first assist image may be displayed in response to the user operation that requests the display of the first assist image, and the first assist image may be erased from the screen of the display unit 105 in response to the user operation that requests non-display of the first assist image.

In addition, the first assist image is not limited to the images shown in FIGS. 8, 9A, and 9B. For example, an image in which various areas (the already-displayed area, the non-displayed area, the target partial area to be displayed currently, and the like) are mapped in a spherical image (doughnut-shaped omnidirectional image) may be generated as the first assist image instead of the plane image by using, e.g., an existing geometric transformation process. A subject may not be depicted in the first assist image. Various areas may be displayed so as to be identifiable by using various lines (a solid line, a broken line, a one-dot chain line, a thick line, a thin line, a red line, a blue line, and the like). Various areas may be displayed so as to be identifiable using a coordinate value indicative of the area and text indicative of the type of the area. Various areas may be displayed so as to be identifiable using the brightness and color of the area. In a case where the already-displayed area is displayed, the user can easily grasp the non-displayed area, and hence the non-displayed area may not be displayed. The target partial area to be displayed currently may not be displayed. In this case, it is not necessary to use the selection result of the selection process in the generation of the first assist image.

### Operation

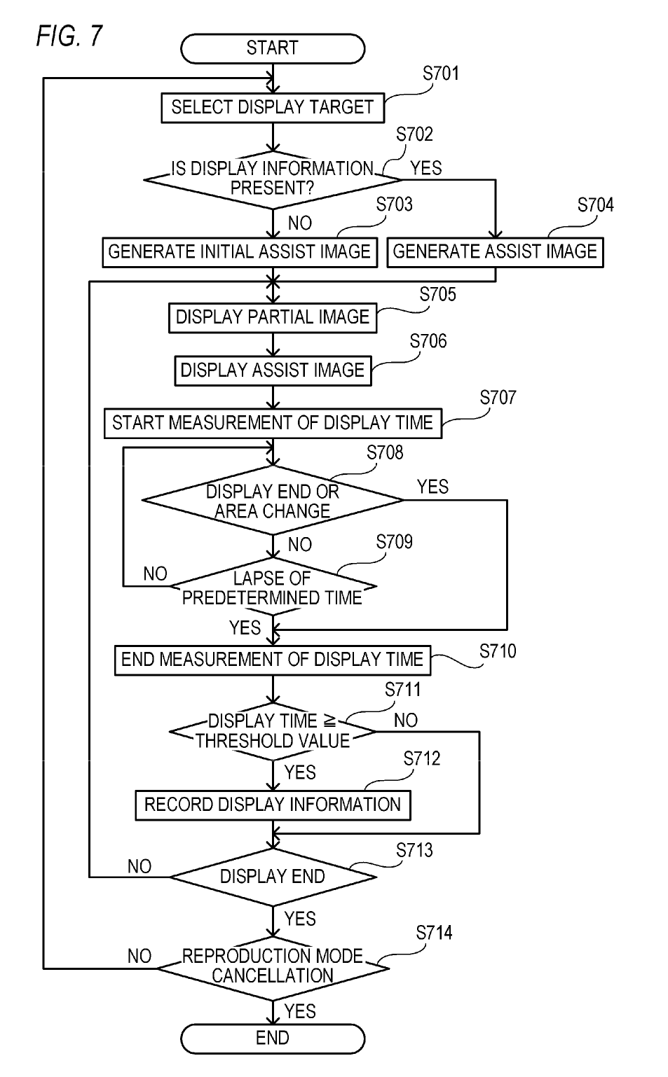

Next, an example of the operation of the digital camera according to the present embodiment will be described by using FIG. 7. FIG. 7 is a flowchart showing an example of the operation of the digital camera 100. The flowchart in FIG. 7 is executed in the case where, as an operation mode of the digital camera 100, for example, a reproduction mode that displays (reproduces) the stored photographed image is set. FIG. 7 shows an example in which the first assist image is automatically displayed during the execution of the first display control. Note that the display method of the first assist image is not particularly limited, and hence the timing of display of the first assist image is not limited to the following timing.

First, in S701, the control unit 109 selects one of a plurality of photographed images stored in the storage unit 106 as the target image to be displayed in response to the user operation (selection operation) to the digital camera 100. Specifically, in a case where the selection operation is performed, a selection signal corresponding to the selection operation is outputted to the control unit 109 from the operation unit 104. Subsequently, the control unit 109 selects the target photographed image to be displayed in response to the selection signal. The selection operation is, e.g., the user operation that selects one of a plurality of thumbnail images (a plurality of thumbnail images corresponding to a plurality of photographed images) displayed in the display unit 105 by the control unit 109.

Next, in S702, the control unit 109 determines whether or not the storage unit 106 stores the display information (corresponding display information) corresponding to the photographed image (selected image) selected in S701. In the case where it is determined that the storage unit 106 does not store the corresponding display information, the process is advanced to S703 and, in the case where it is determined that the storage unit 106 stores the corresponding display information, the process is advanced to S704.

In S703, the assist image generation unit 107 generates the assist image (initial assist image) in which only the initial partial area is shown as the already-displayed area. In S704, the assist image generation unit 107 acquires the corresponding display information from the storage unit 106 via the control unit 109, and generates the assist image by using the acquired corresponding display information. Then, the process is advanced from S703 or S704 to S705.

In S705, the control unit 109 performs the selection process that selects the partial area, and performs the first display control in which the display unit 105 is caused to perform the display of the selected image in the selected partial area (display of the partial image). In the first process, the initial partial area is selected.

Next, in S706, the control unit 109 performs the second display control in which the display unit 105 is caused to perform the display of the assist image generated in S703 or S704. With this process, the assist image generated in S703 or S704 is superimposed on the partial image displayed in S705 and displayed.

Subsequently, in S707, the display time measurement unit 108 starts the measurement of the display time of the partial image (target partial image) displayed in S705.

Next, in S708, the control unit 109 determines whether or not the user operation (end operation) that ends the display of the selected image (the partial image of the selected image) or the specification operation that changes the target partial area to be displayed has been performed. The process in S708 can be implemented by monitoring the signal outputted from the operation unit 104 in response to the user operation by the control unit 109. In the case where it is determined that the end operation or the specification operation has not been performed, the process is advanced to S709 and, in the case where it is determined that the end operation or the specification operation has been performed, the process is advanced to S710.

In S709, the control unit 109 determines whether or not the measurement value of the display time measurement unit 108 (measurement time; the display time of the target partial image) has reached a predetermined time. In the case where it is determined that the measurement value has reached the predetermined time, the process is advanced to S710 and, in the case where it is determined that the measurement value has not reached the predetermined time, the process is returned to S708. The predetermined time is a time not less than a first threshold value described later.

In S710, the display time measurement unit 108 ends the measurement of the display time of the target partial image.

Next, in S711, the control unit 109 determines whether or not the measurement value (a time from the timing at which the process in S707 has been per formed to the timing at which the process in S710 has been performed) of the display time measurement unit 108 is not less than the first threshold value. In the case where it is determined that the measurement value is not less than the first threshold value, the control unit 109 determines the area of the target partial image (partial area) as the already-displayed area, and the process is advanced to S712. In the case where it is determined that the measurement value is less than the first threshold value, the control unit 109 determines the area of the target partial image as the non-displayed area, and the process is advanced to S713. Note that the first threshold value may be a fixed value that is predetermined by a maker, or may also be a value that can be changed by the user. Note that the threshold value for determining the already-displayed area and the threshold value for determining the non-displayed area may be different from each other. That is, the partial area may be determined as the already-displayed area in a case where the measurement value is larger than the first threshold value, and the partial area may be determined as the non-displayed area in a case where the measurement value is smaller than a second threshold value. Herein, as the second threshold value, a value smaller than the first threshold value is set.

Herein, consideration will be given to the case where the position of the partial area is scrolled. In such a case, there are cases where a part of the partial image is displayed only for a short time period during the scrolling. It is unlikely that the partial image displayed only for a short time period remains in the memory of the user, and hence it is not preferable to treat the area of the partial image displayed only for a short time period as the already-displayed area. To cope with this, in the present embodiment, in the case where the display time of the partial image is less than the first threshold value, the process in S712 is omitted. Accordingly, the area of the partial image displayed only for a short time period is not treated as the already-displayed area. On the other hand, the area of the partial image displayed only for a short time period can be considered as the area that is not important for the user. Accordingly, the area of the partial image displayed in S705 may be treated as the already-displayed area irrespective of the length of the display time. In this case, the display time measurement unit 108 is not necessary.

In S712, the control unit 109 generates the corresponding display information in which the area of the target partial image (partial area) is represented as the already-displayed area, and records the generated corresponding display information in the storage unit 106. In the case where the storage unit 106 has already stored the corresponding display information, the control unit 109 updates the corresponding display information stored in the storage unit 106 such that the area of the target partial image (partial area) is added to the already-displayed area. Subsequently to S712, the process is advanced to S713.

In S713, the control unit 109 determines whether or not the end operation has been performed. In the case where it is determined that the end operation has not been performed, the process is returned to S705. At this point, in the case where the determination result that “the specification operation that changes the partial area has been performed” is obtained as the determination result in S708, in S705, the partial area after the change is selected by the selection process. In the case where it is determined that the end operation has been performed, the process is advanced to S714. In the case where it is determined that the end operation has not been performed, the process may be returned to S702. With this, it is possible to update the first assist image in real time and display the first assist image.

In S714, the control unit 109 determines whether or not a mode cancellation operation as the user operation that cancels the setting of the reproduction mode has been performed. The process in S714 can be implemented by monitoring the signal outputted from the operation unit 104 in response to the user operation by the control unit 109. In the case where it is determined that the mode cancellation operation has not been performed, the process is returned to S701 and, in the case where it is determined that the mode cancellation operation has been performed, the present flowchart is ended.

Hereinbelow, specific examples of the update of the display information and the first assist image will be described. Herein, it is assumed that the storage unit 106 stores the display information in which the area that is not hatched in FIG. 9A is represented as the already-displayed area. In addition, it is assumed that the partial area 901 has been selected by the selection process in S705.

In this case, in S704, the first assist image shown in FIG. 9A is generated. Subsequently, with the processes in S705 and S706, the image in which the first assist image in FIG. 9A is superimposed on the original image (selected image) in the partial area 901 is displayed.

Herein, it is assumed that the display time of the original image in the partial area 901 is not less than the first threshold value, and viewing of the original image is ended after the original image in the partial area 901 is displayed. In this case, it is determined that the partial area 901 is the already-displayed area. Subsequently, with the process in S712, the display information is updated from the display information in which the area that is not hatched in FIG. 9A is represented as the already-displayed area to the display information in which the area that is not hatched in FIG. 9B is represented as the already-displayed area. As a result, at the time of the next viewing, the first assist image in FIG. 9B is displayed instead of the first assist image in FIG. 9A.

With this, the user can easily distinguish between the non-displayed area and the already-displayed area and grasp them, and it is possible to change the target partial area to be displayed such that the entire plane image is scanned thoroughly and efficiently.

Thus, according to the present embodiment, the first assist image that shows the already-displayed area is generated and displayed. With this, the user can easily distinguish between the non-displayed area and the already-displayed area and grasp them.

Note that, in the present embodiment, the example in the case where the original image is the photographed image and is also the omnidirectional image having been subjected to the distortion correction process has been described, but the original image is not limited thereto. The original image may be any image. For example, the original image may be an omnidirectional image before being subjected to the distortion correction process. The original image may also be a panoramic image in which a view in a wide range that is not omnidirectional is imaged. The original image may not be the photographed image. For example, the original image may also be an illustration image.

### Second Embodiment

Hereinbelow, the control apparatus and the control method according to a second embodiment of the present invention will be described. In the first embodiment, the example in which the target partial area to be displayed is changed in response to the specification operation has been described. In the present embodiment, an example in which the target partial area to be displayed is automatically changed will be described. The functional configuration of the digital camera according to the present embodiment is the same as that in the first embodiment (FIG. 1), and hence the description thereof will be omitted.

### Operation

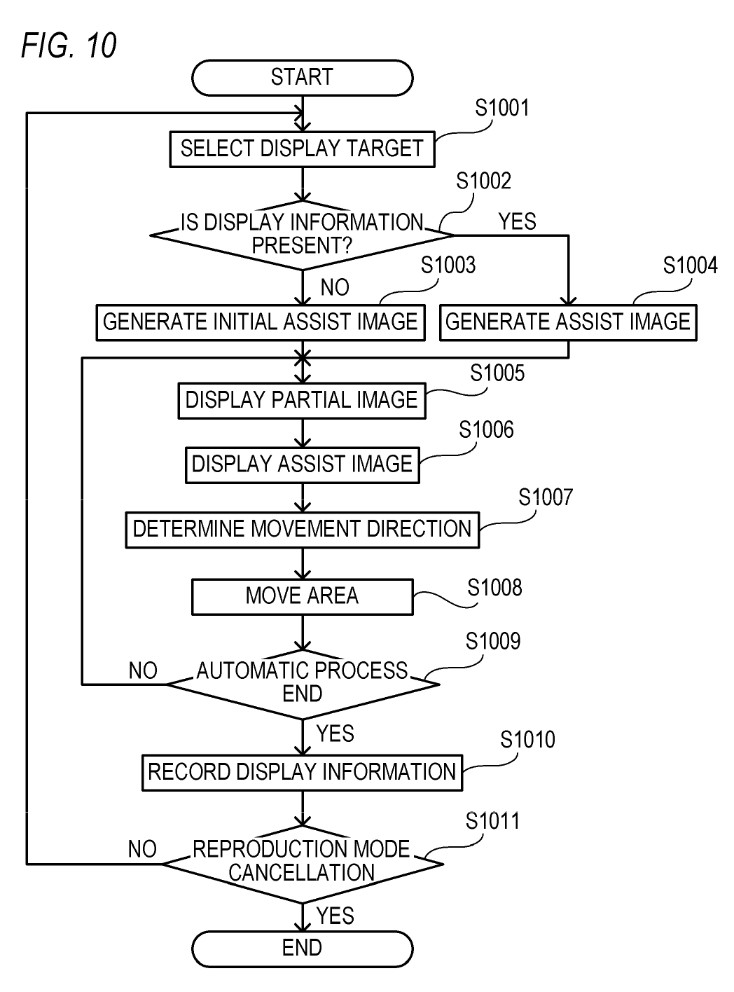

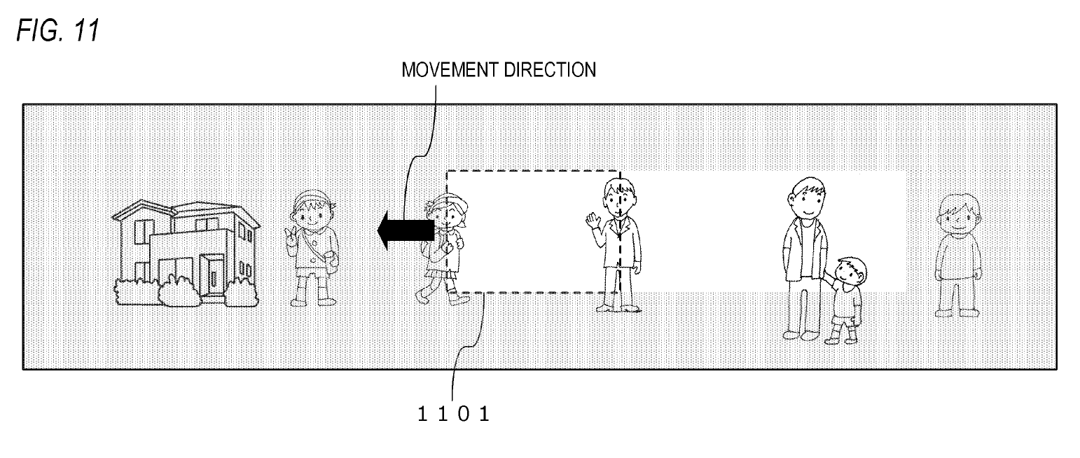

An example of the operation of the digital camera according to the present embodiment will be described by using FIG. 10. FIG. 10 is a flowchart showing an example of the operation of the digital camera 100. Processes in S1001 to S1006 are the same as the processes in S701 to S706 in the first embodiment (FIG. 7) , and hence the description thereof will be omitted. After S1006, the process is advanced to S1007. Herein, it is assumed that the display information corresponding to FIG. 9 is acquired in S1004. In addition, it is assumed that the first assist image shown in FIG. 11 is displayed in S1006. An area surrounded by a broken line 1101 is the target partial area to be displayed currently, and is the initial partial area.

In S1007 and S1008, the control unit 109 updates the target partial area to be displayed by selecting the partial area based on the corresponding display information. In the present embodiment, the control unit 109 selects the non-displayed area in preference to the other area.

Specifically, in S1007, the control unit 109 determines the movement direction of the target partial area to be displayed based on the corresponding display information. As shown in FIG. 11, an area on the right of a partial area 1101 is an already-displayed area, while areas above, below, and on the left of the partial area 1101 are non-displayed areas. In S1007, the control unit 109 selects a direction in which the non-displayed area is positioned adjacent to the target partial area to be displayed. In the case where the direction in which the non-displayed area is positioned adjacent to the target partial area to be displayed does not exist, and the non-displayed area exists at a position apart from the target partial area to be displayed, a direction toward the non-displayed area from the target partial area to be displayed is selected.

In S1008, the control unit 109 moves the target partial area to be displayed in the movement direction determined in S1007. In addition, the control unit 109 updates the corresponding display information such that the area of the partial image displayed in S1005 is added to the already-displayed area.

In the plane image, the height of the central portion of the plane image (the position in the vertical direction) often substantially matches the height of the eyes of the user. It is likely that a subject that is not important for the user is shown above and below the central portion. In other words, it is likely that a subject that is important for the user is not shown above and below the central portion. Specifically, it is likely that the sky, the ceiling of a building, and the like are shown above the central portion, and it is likely that the ground and the like are shown below the central portion. Accordingly, the area positioned in the horizontal direction with respect to the area of the central portion (predetermined area) in the non-displayed area is preferably selected in preference to the other area. For example, the direction to the right or the left from the partial area 1001 is preferably selected in preference to the other directions from the partial area 1001. Accordingly, in an example in FIG. 11, the left direction is selected as the movement direction of the partial area 1101. Note that the predetermined area may not be the area of the central portion.

As long as the non-displayed area is selected in preference to the other area, the method of selecting the target partial area to be displayed (update method) may be any method (algorithm) . For example, the target partial area to be displayed may be changed discontinuously instead of changing (moving) the target partial area to be displayed continuously. In addition, the target partial area to be displayed may also be selected such that an area of an image having a predetermined characteristic is selected in preference to the other area. There are cases where the display of the partial image is performed in order for the user to identify the face of a person. Accordingly, the target partial area to be displayed may also be selected such that an area including the image having the face of the person is selected in preference to the other area. Further, the target partial area to be displayed may also be selected such that an area including a larger number of the images each having the face of the person is selected in preference to the other area.

Subsequently to S1008, in S1009, the control unit 109 determines whether or not an automatic process end operation has been performed. The automatic process end operation is the user operation that ends a process of automatically updating the target partial area to be displayed such that the non-displayed area is preferentially selected, and includes the end operation described in the first embodiment. The digital camera 100 may have a non-automatic update mode in which the target partial area to be displayed is updated in response to the specification operation, and an automatic update mode in which the target partial area to be displayed is automatically updated. In this case, the automatic process end operation includes a switching operation as the user operation that switches the operation mode from the automatic update mode to the non-automatic update mode. The switching operation includes the specification mode that changes the target partial area to be displayed.

In the case where it is determined that the automatic process end operation has not been performed, the process is returned to S1005 and, in the case where it is determined that the automatic process end operation has been performed, the process is advanced to S1010. In the case where the entire area of the selected image has become the already-displayed area, the process may be advanced to S1010.

In S1010, the control unit 109 records the corresponding display information in the storage unit 106 (save or overwrite).

Next, in S1011, the control unit 109 determines whether or not the mode cancellation operation has been performed. In the case where it is determined that the mode cancellation operation has not been performed, the process is returned to S1001 and, in the case where it is determined that the mode cancellation operation has been performed, the present flowchart is ended.

Herein, consideration will be given to the case where the process is advanced from S1009 to S1010 by the user operation that switches the operation mode from the automatic update mode to the non-automatic update mode (switching operation). In this case, after the process in S1010 is performed, the process is advanced to S705 in FIG. 7.

Thus, according to the present embodiment, the target partial area to be displayed is automatically selected. With this, it is possible to save time and effort of the user who specifies the target partial area to be displayed, and convenience is thereby improved. In addition, since the non-displayed area is selected in preference to the other area, it is possible to change the target partial area to be displayed such that the entire plane image is scanned thoroughly and efficiently.

### Third Embodiment

Hereinbelow, the control apparatus and the control method according to a third embodiment of the present invent ion will be described. The functional configuration of the digital camera according to the present embodiment is the same as that in the first embodiment (FIG. 1). In the present embodiment, the assist image generation unit 107 is capable of generating not only the first assist image but also a second assist image (second auxiliary image). In addition, the control unit 109 is capable of further executing third display control in which the display unit 105 is caused to perform the display of the second assist image.

The second assist image is generated based on the display information recorded in the storage unit 106 (second generation process). The second assist image indicates any of a display ratio, a non-display ratio, and read information. The display ratio is the ratio of the already-displayed area to the entire area of the original image, and the non-display ratio is the ratio of the non-displayed area to the entire area of the original image. The read information indicates whether or not the entire area of the original image has already been displayed.

Note that the timings of generation of the display ratio, the non-display ratio, the read information, and the second assist image are not particularly limited. For example, the display ratio, the non-display ratio, and the read information may be generated during the third display control, and the second assist image may be generated. The display ratio, the non-display ratio, the read information, and the second assist image may be generated during the execution of the process in S712 in FIG. 7, and the generated data (the information and the image) may be recorded in the storage unit 106. The display ratio, the non-display ratio, and the read information may be generated during the execution of the process in S712 in FIG. 7, and the generated information may be recorded in the storage unit 106. Further, the display ratio, the non-display ratio, and the read information may be read from the storage unit 106 during the third display control, and the second assist image may be generated.

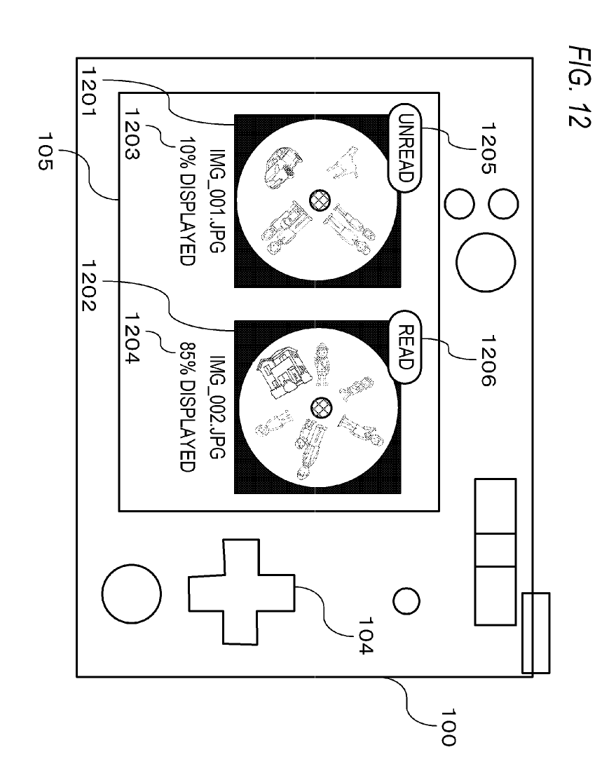

FIG. 12 is a view showing an example of the second assist image. In the example in FIG. 12, two thumbnail images 1201 and 1202 corresponding to two photographed images are displayed. The selection operation performed in S701 in FIG. 7 is the user operation that selects one of a plurality of thumbnail images displayed in this manner. In the example in FIG. 12, the second assist image is displayed in association with the thumbnail image.

Reference numerals 1203 and 1204 denote text images indicative of the display ratio. The text image 1203 indicates the display ratio of the photographed image corresponding to the thumbnail image 1201, and the text image 1204 indicates the display ratio of the photographed image corresponding to the thumbnail image 1202. FIG. 12 shows an example in which the display ratio of the photographed image corresponding to the thumbnail image 1201 is 10%, and the display ratio of the photographed image corresponding to the thumbnail image 1202 is 85%. Accordingly, in the example in FIG. 12, the text image having text “10% displayed” is used as the text image 1203, and the text image having text “85% displayed” is used as the text image 1204.

Note that an image indicative of the non-display ratio instead of the display ratio may be displayed. An image indicative of both of the display ratio and the non-display ratio may also be displayed. In addition, as the image indicative of the display ratio or the non-display ratio, an image other than the text image (e.g., a graphic image) may al so be used. For example, a bar image indicative of the display ratio and the non-display ratio may be displayed.

Reference numerals 1205 and 1206 denote text images indicative of the read information. The text image 1205 indicates the read information of the photographed image corresponding to the thumbnail image 1201, and the text image 1206 indicates the read information of the photographed image corresponding to the thumbnail image 1202. In the case where the display ratio is not less than a third threshold value, the assist image generation unit 107 determines that the original image itself has already been displayed and, in the case where the display ratio is less than the third threshold value, the assist image generation unit 107 determines that the original image itself is not yet displayed. FIG. 12 shows an example in which the third threshold value is 80%. Accordingly, in the example in FIG. 12, as the text image 1205, a text image “unread” indicating that many non-displayed areas are present is used. In addition, as the text image 1206, a text image “read” indicating that most of the area of the original image is the already-displayed area is used.

Note that the third threshold value may be a fixed value that is predetermined by a maker, or may also be a value that can be changed by the user. 100% may be used as the third threshold value. In addition, in the case where the entire area of the original image is the already-displayed area, the text image “read” may be used and, otherwise, the text image “unread” may be used. As the image indicative of the read information, an image other than the text image (e.g., a graphic image) may be used. For example, in the case where the display ratio is not less than the third threshold value, a first icon image may be used and, in the case where the display ratio is less than the third threshold value, a second icon image may be used.

Note that the threshold value for determining whether or not the original image itself has already been displayed and the threshold value for determining whether or not the original image itself is not yet displayed may be different from each other. That is, it may be determined that the original image itself has already been displayed in a case where the display ratio is larger than the third threshold value, and it may be determined that the original image itself is not yet displayed in a case where the display ratio is smaller than a fourth threshold value. Herein, as the fourth threshold value, a value smaller than the third threshold value is set. Further, in a case where it is determined that the original image itself has already been displayed or not yet displayed, the non-display ratio may also be used.

In addition, in the example in FIG. 12, file names of the thumbnail images (“IMG_001. JPG”, “IMG_002. JPG”) are displayed. The text image of the fine name may or may not be viewed as a part of the second assist image.

The display ratio, the non-display ratio, the read information, and the file name may be used for file classification (sorting of the thumbnail image, retrieval of the photographed image, or the like) . For example, by using the display ratio, sorting of the thumbnail image may be performed such that the thumbnail images are displayed in the order of the display ratio. By using the read information, an unread photographed image (a photographed image in which the area of the original image is determined to include the non-displayed area) may be retrieved from a plurality of photographed images.

Note that the display method of the second assist image is not particularly limited. For example, the thumbnail image may not be displayed and only the second assist image may be displayed. The second assist image may be superimposed on an image other than the thumbnail image (e.g., the partial image) and displayed. The second assist image may or may not be automatically displayed only during the display of the thumbnail image. The second assist image may be displayed in response to the user operation that requests the display of the second assist image, and the second assist image may be erased from the screen of the display unit 105 in response to the user operation that request the non-display of the second assist image.

Thus, according to the present embodiment, the second assist image indicative of at least any of the display ratio, the non-display ratio, and the read information is displayed. With this, the user can easily grasp the original image that is not yet checked and the image that has already been checked, and efficiently select and check the original image that is not yet checked.

Hitherto, the preferred embodiments of the present invention have been described, but the present invention is not limited to the embodiments, and may be modified or changed in various ways within the scope of the gist thereof.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-108636, filed on May 28, 2015, which is hereby incorporated by reference herein in its entirety.

What is claimed is:

1. A control apparatus comprising:
a processor; and
a memory storing a program which, when executed by the processor, causes the control apparatus to:
select a part of an original image;
perform displaying the selected part of the original image in a display unit;
record, in association with the original image, information which indicates the part of the original image has already been displayed in the display unit, in a storage unit; and
perform displaying the original image in the display unit based on the information recorded in the storage unit so as to discriminate which part of the original image has already been displayed.

2. The control apparatus according to claim 1, wherein
the original image is displayed in the display unit with the selected part and the already-displayed part being made identifiable based on the selection of the part of the original image to be displayed in the display unit and the information recorded in the storage unit.

3. The control apparatus according to claim 1, wherein
the program further causes the control apparatus to:
measure a time while the part of the original image is displayed in the display unit, and
record information indicating that the part of the original image has already been displayed if the measured time is larger than a threshold value.

4. The control apparatus according to claim 1, wherein
the part of the original image that is not yet displayed is selected as a non-displayed area in preference to another part of the original image that has already been displayed based on the information recorded in the storage unit.

5. The control apparatus according to claim 4, wherein
the part of the original image corresponding to an area positioned in a horizontal direction with respect to a predetermined area in the non-displayed area is selected in preference to another part.

6. The control apparatus according to claim 5, wherein
the predetermined area is an area in a central portion of the original image.

7. The control apparatus according to claim 4, wherein
the part of the original image corresponding to an area of an original image having a predetermined characteristic is selected in preference to another part.

8. The control apparatus according to claim 7, wherein
the part of the original image having the predetermined characteristic includes an image of a face.

9. The control apparatus according to claim 8, wherein
the part of the original image having the predetermined characteristic includes an image of a larger number of the faces than that of another part of the original image.

10. The control apparatus according to claim 1, wherein
the program further causes the control apparatus to:
calculate at least one of a display ratio as a ratio of the part of the original image that has already been displayed to an entire area of the original image and a non-display ratio as a ratio of the part of the original image that is not yet displayed to the entire area of the original image, based on the information recorded in the storage unit; and
perform displaying at least one of the display ratio, the non-display ratio, and display information indicating whether or not the original image has al ready been displayed in the display unit.

11. The control apparatus according to claim 10, wherein
the display information indicating that the original image has already been displayed is displayed in the display unit if the display ratio is larger than a first threshold value,
the display information indicating that the original image is not yet displayed is displayed in the display unit if the display ratio is smaller than a second threshold value, and
the first threshold value is not less than the second threshold value.

12. A display control method comprising:
selecting a part of an original image;
performing displaying the selected part of the original image in a display unit;
recording, in association with the original image, information which indicates the part of the original image has already been displayed in the display unit in a storage unit; and
performing displaying the original image in the display unit based on the information recorded in the storage unit so as to discriminate which part of the original image has already been displayed.

13. A non-transitory computer readable medium that stores a program, wherein the program causes a computer to execute:
selecting a part of an original image;
performing displaying the selected part of the original image in a display unit;
recording, in association with the original image, information which indicates the part of the original image has already been displayed in the display unit in a storage unit; and
performing displaying the original image in the display unit based on the information recorded in the storage unit so as to discriminate which part of the original image has already been displayed.
